(19) United States
(12) Patent Application Publication
(10) Pub. No.: US 2015/0296570 A1
(43) Pub. Date: Oct. 15, 2015

(54) INDUCTION COOKING TOP

(71) Applicant: INDESIT COMPANY S.P.A., Fabriano (AN) (IT)

(72) Inventors: Davide Altamura, Fabriano (IT); Diego Bariviera, Fabriano (IT); Alessio Beato, Fabriano (IT)

(21) Appl. No.: 14/435,814

(22) PCT Filed: Oct. 14, 2013
(86) PCT No.: PCT/IB2013/059340

§ 371 Date: Apr. 15, 2015

(30) Foreign Application Priority Data
Oct. 15, 2012 (IT) TO2012A000896

(51) Int. Cl. H05B 6/06; H05B 6/12

(52) U.S. Cl. CPC H05B 6/065; H05B 6/12

(57) ABSTRACT

The present disclosure relates to an induction cooking top comprising a system adapted to modify the control of the presence of the pan on the induction cooking top, upon a command by the user.

### FIELD OF THE INVENTION

The present invention relates to an induction cooking top according to the preamble of claim 1.

STATE OF THE ART

Induction cooking tops are devices which exploit the phenomenon of induction heating for food cooking purposes. Induction cooking tops comprise a top made of glass-ceramic material upon which cooking units are positioned (hereinafter “pans”). Moreover there are provided inductors comprising coils of copper wire where an oscillating current (e.g. an alternating current) is circulated producing an oscillating electromagnetic field. The electromagnetic field has the main effect of inducing a parasitic current inside the pan, which is made of an electrically conductive ferromagnetic material. The parasitic current circulating in the pan produces heat by dissipation; such heat is generated only within the pan and it acts without heating the cooking top.

This type of flameless cooking top has a better efficiency than electric cooking tops (i.e. a greater fraction of the absorbed electric power is converted into heat that heats the pan). In addition induction cooking tops are safer to use due to the absence of hot surfaces or flames, reducing the risk of burns for the user or of fire.

The presence of the pan on the cooking top causes the magnetic flux to close on the pan itself causing the power to be transferred towards the pan. The greater the size of the pan, the higher the power that can be transferred.

Since heat is generated by induced currents, the cooking top control system monitors the currents flowing through the coils; in this way, the power supplied to each inductor can be adjusted automatically. Moreover such current monitoring allows to automatically detect the presence of a pan over the inductors and to automatically turn them off in the absence of the pan on the cooking top.

A drawback arising from such controls, is that it is possible for small pans not to be detected and therefore such condition, corresponding to the absence of the pan, does not lead to cooking, since the cooking top control system does not activate the inductors, that is it does not activate the passage of the current through the coils of the inductors.

### SUMMARY OF THE INVENTION

The object of the present invention is to provide an induction cooking top capable of solving the drawbacks of the prior art.

A further object of the present invention is to provide an induction cooking top which is simpler and cheaper to manufacture.

A further object of the present invention is to provide a cooking top which is easier to control and to adjust.

The general idea at the base of the present invention is to provide the cooking top with a system adapted to modify the pan presence control, upon a command by the user.

Preferably the modification provides to deactivate or to modify the control parameters of said automatic control.

These and other objects of the present invention are achieved by means of a cooking top incorporating the features set out in the appended claims, which are an integral part of the present description.

### BRIEF DESCRIPTION OF THE FIGURES

Further objects and advantages of the present invention will become more apparent from the following detailed description and from the annexed drawing, which is provided by way of a non-limiting example, wherein:

FIG. 1 is a top view of a cooking top according to the present invention.

### DETAILED DESCRIPTION OF THE EMBODIMENTS

The aim of the present invention is to provide the induction cooking top 1 to be used also in the presence of small pans which are not sensed by the safety system that prevents inductors from being activated when nothing is on the cooking top.

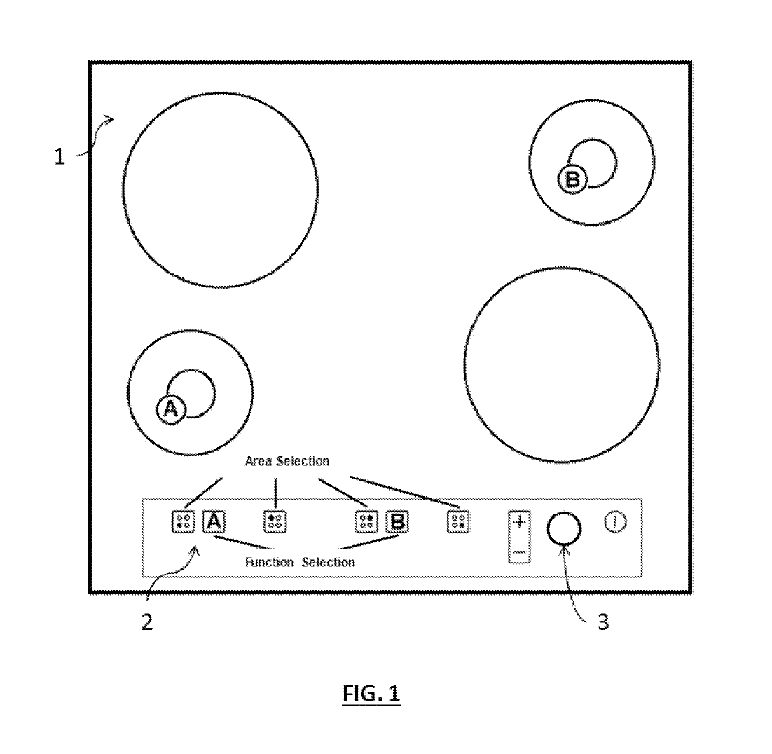

Particularly the pan presence control is carried out for each cooking area of the induction cooking top, in the case this latter is divided into multiple areas, for example four areas (FIG. 1). One pan comprising ferromagnetic material can be positioned on each area. Usually the areas can have a different size for differently sized pans.

It is known that in case of a too small size of the object on the induction cooking top, the system does not activate, for example in the presence of metallic cutlery on the top such to avoid the latter to be heated and to prevent the user from burning himself/herself when he/she touches it. Moreover the system does not activate also in the presence of nonmetallic objects.

Therefore the system does not activate in the presence of a pan having such a size to have a surface in contact with the induction cooking top smaller than a size threshold (for example 50 cm²) and this can be an undesired operation, since in this case the user would like the system to operate and to activate. However the control has to be provided for safety purposes.

According to the present invention, a system is provided which is adapted to modify the pan presence control, upon a command by the user, which has to be activated when the user decides to place a small-sized pan on the induction cooking top.

Said modification can provide the control to be deactivated, or the control parameters to be modified, for example such to lower the pan presence detection threshold.

Thus it is possible to use a small-sized pan which otherwise would be useless.

According to a possible variant, the cooking top has an interface 2 of the “touch” type containing manual controls. Preferably on the interface 2 one or more dedicated push-buttons (A, B) are inserted, upon the activation thereof the pan presence control is modified.

Preferred variants for safety purposes can provide a particular sequence of commands and/or activations of push-buttons A, B intended to by-pass the pan presence control.

Further variants can provide the activation of the system of the invention to determine the reduction in the maximum power output.

Further variants can provide a control of the maximum time of power output and the subsequent deactivation.

In the case the induction cooking top is divided into multiple areas upon each of them it being possible to position a pan, the system of the invention can be provided only for one area, for example the one with the smallest size and therefore with the lowest maximum power output.

In order to deactivate the pan presence control modification mode, for example at the end of cooking, besides the manual deactivation by the user, it is possible to provide the system to periodically request a repetition of the pan presence control modification mode, otherwise it deactivates said modification mode automatically after a predetermined time period.

It is apparent that many changes may be made to the present invention by those skilled in the art without departing from the protection scope thereof as stated in the appended claims.

From the description above, a person skilled in the art will be able to implement the object of the invention without introducing further constructional details.

1. An induction cooking top (1), comprising:
a cooktop
inductors, configured on the cook top; and
an automatic control system, the automatic control system in communication with the inductors and adapted to check for the presence of any cooking pans on said cook top in order to prevent the inductors from activating in the absence of any cooking pans on said cooking top, wherein the automatic control system is activated upon receiving an activation command.

2. A cooking top according to claim 1, wherein said modification system is adapted to at least one of deactivate and modify the control parameters of said automatic control.

3. A cooking top according to claim 2, wherein said modification of the control parameters lowers a pan presence detection threshold.

4. A cooking top according to claim 1, wherein said modification system comprises at least one of a sequence of activation commands and one or more activation push-buttons (A, B).

5. A cooking top according to claim 1, wherein said modification system is adapted to determine a reduction in the maximum induction power output.

6. A cooking top according to claim 1, wherein said modification system comprises means for controlling the maximum time of induction power output, and the subsequent deactivation.

7. A cooking top according to claim 1, wherein said modification system comprises means for periodically requesting a repetition of said activation command, and means for deactivating said modification mode in the event that said repetition is not carried out.

8. A cooking top according to claim 1, wherein in the case of an induction cooking top divided into multiple areas, said modification system is only associated with one area.

9. A method of controlling a cooktop, comprising:
supplying a cooktop;
configuring at least one inductor on a top surface of the cooktop;
providing an automatic control system;
connecting the control system with the at least one inductor;
positioning a small pan on the at least one inductor; and
activating the control system, wherein activation of the control system at least one of deactivates and modifies a pan presence detection threshold.

10. The method of claim 9, wherein the automatic control system is a pan presence control system.

11. The method of claim 10, further comprising activating at least one control on a user interface thereby activating the control system.

12. The method of claim 9, wherein the small pan is a pan smaller than 50 cm².

13. The method of claim 9, further comprising; requesting periodically a repetition of said control system activation, and deactivating the pan presence detection in the event that said repetition is not carried out.
